(19) United States
(12) Patent Application Publication
(10) Pub. No.: US 2024/0421894 A1
(43) Pub. Date: Dec. 19, 2024

(54) CELL SEARCH IN NON-TERRESTRIAL NETWORKS WITH DISCONTINUOUS COVERAGE

(71) Applicant: Nokia Technologies Oy, Espoo (FI)

(72) Inventors: Sandra HOPPE, Munich (DE); Jeroen WIGARD, Aalborg (DK); Mads LAURIDSEN, Aalborg (DK); Srinivasan SELVAGANAPATHY, Bangalore (IN)

(21) Appl. No.: 18/701,586

(22) PCT Filed: Oct. 11, 2022
(86) PCT No.: PCT/EP2022/078167

§ 371 Date: Apr. 15, 2024

(30) Foreign Application Priority Data
Oct. 20, 2021 (IN) 202141047568

(51) Int. Cl. H04B 7/185

(52) U.S. Cl. CPC H04B 7/18519; H04B 7/18539

(57) ABSTRACT

Various example embodiments relate to a solution for non-terrestrial network communication. A user device for non-terrestrial network communication may be configured to determine that a connection to a non-terrestrial network having a discontinuous coverage is unavailable, the non-terrestrial network providing at least one cell serving the user device; obtain data relating to cell availability of the at least one cell; determine a backoff time associated with a subsequent non-terrestrial network search based at least partly on the data relating to cell availability; and initiate a cell search of the non-terrestrial network again after expiration of the backoff time.

### TECHNICAL FIELD

Various example embodiments generally relate to the field of wireless data communications. In particular, some example embodiments relate to a solution for non-terrestrial networks with a discontinuous coverage.

### BACKGROUND

Non-terrestrial networks comprise networks that may use an airborne or spaceborne platform as a part of the network, such as satellites, high-altitude platforms or drones. Satellites can be classified in terms of their altitude, from low-Earth orbit (LEO) to geostationary Earth orbit (GEO) satellites. LEO satellites are deployed in large constellations and move with respect to the Earth's surface with a speed of approximately 7, 5 km/s to maintain their orbit. An advantage of the LEO satellites is global and high-speed communication with a low delay in comparison to traditional GEO satellites due to the lower round-trip time (RTT). As the LEO satellites move with respect to the Earth, this will lead to very frequent handovers, even if a user equipment (UE) serve by the LEO satellites is not moving.

The NTN networks may provide a discontinuous coverage. The discontinuous coverage refers to a situation in which at some specific time intervals, the UE is not covered by any satellite (for example, LEO, GEO or LEO/GEO). This means that during these time intervals, cells provided by base stations (i.e. gNBs) are only sporadically available to the UEs. The discontinuous coverage can be either per design or just in the initial deployment of the constellation, where the number of satellites is insufficient to provide continuous coverage.

The NTN communication may be performed by a variety of devices. These devices are commonly referred to as UE. The UE may be, for example, a mobile device, a smart phone, an Internet of Things (IoT) device etc. With some devices, for example, the IoT devices one challenging issue may be the energy consumption in case of the discontinuous coverage. A continuous search for coverage (i.e. cells) may be energy consuming, and this may cause a challenge especially for a device that has limited power resources.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

Example embodiments may provide a solution that allows balancing delay and power saving when trying to connect to a non-terrestrial network having a discontinuous coverage. This benefit may be achieved by the features of the independent claims. Further implementation forms are provided in the dependent claims, the description, and the drawings.

According to a first aspect, a user device for non-terrestrial network communication may comprise at least one processor and at least one memory including computer program code. The at least one memory and the computer program code are configured to, with the at least one processor, cause the user device at least to: determine that a connection to a non-terrestrial network having a discontinuous coverage is unavailable, the non-terrestrial network providing at least one cell serving the user device; obtain data relating to cell availability of the at least one cell; determine a backoff time associated with a subsequent non-terrestrial network search based at least partly on the data relating to cell availability; and initiate a cell search of the non-terrestrial network again after expiration of the backoff time.

In an example embodiment, the at least one memory and the computer program code are configured to, with the at least one processor, cause the user device at least to obtain the data relating to cell availability of the at least one cell from a subscriber identity module associated with the user device.

In an example embodiment, the at least one memory and the computer program code are configured to, with the at least one processor, cause the user device at least to obtain the data relating to cell availability of the at least one cell from the non-terrestrial network as a broadcast transmission.

In an example embodiment, the at least one memory and the computer program code are configured to, with the at least one processor, cause the user device at least to obtain the data relating to cell availability of the at least one cell from the non-terrestrial network as dedicated signaling.

In an example embodiment, the at least one memory and the computer program code are configured to, with the at least one processor, cause the user device at least to obtain the data relating to cell availability of the at least one cell based on information learned by the user device based at least partly on at least one previous availability of radio coverage of the non-terrestrial network.

In an example embodiment, the data relating to the cell availability of the at least one cell is associated with a validity time, and the at least one memory including computer program code, the at least one memory and the computer program code are configured to, with the at least one processor, cause the user device at least to initiate the cell search of the non-terrestrial network based on the data relating to the cell availability of the at least one cell, when the data has a non-expired validity time.

In an example embodiment, the at least one memory and the computer program code are configured to, with the at least one processor, cause the user device at least to modify a cell search interval of the non-terrestrial network when the validity time has expired. In an example embodiment, the cell search interval is modified based at least partly on time criticality of data to be sent by the user device.

In an example embodiment, the at least one memory and the computer program code are configured to, with the at least one processor, cause the user device at least to: determine an accuracy of the data relating to cell availability; and apply a safety margin to the backoff time based on the accuracy.

In an example embodiment, the data relating to cell availability comprises one or more of the following: a cell availability time of at least cell provided by at least one satellite of the non-terrestrial network; a cell availability time of at least cell provided by at least one satellite of the non-terrestrial network at different elevation angles; a satellite periodicity relating to at least one satellite of the non-terrestrial network; a coverage radius of at least cell provided by at least one satellite of the non-terrestrial network; ephemeris data associated with at least one satellite of the non-terrestrial network; and a probability distribution between the satellites of the non-terrestrial network, the probability distribution providing probabilities of being in a radio coverage of a satellite during predetermined time windows.

In an example embodiment, one or more of the cell availability time, the satellite periodicity, the coverage radius, the ephemeris data or the probability distribution is location specific and/or time dependent.

In an example embodiment, the at least one memory and the computer program code are configured to, with the at least one processor, cause the user device at least to determine the backoff time based on the probability distribution, a desired probability of being in a radio coverage of a satellite and a power consumption resulting from the desired probability.

In an example embodiment, the probability distribution between the satellites of the non-terrestrial network is location specific and/or time dependent.

In an example embodiment, the at least one memory and the computer program code are configured to, with the at least one processor, cause the user device at least to: determine a temporal distance to a nearest cell availability time; and determine the backoff time at least partly based on the temporal distance.

In an example embodiment, the user device is a mobile user device.

In an example embodiment, the at least one memory and the computer program code are configured to, with the at least one processor, cause the user device at least to: determine a difference between an earlier location of the user device and a current location of the user device; and determine the backoff time based at least partly on the data relating to cell availability and the difference between the earlier location of the user device and the current location of the user device.

According to a second aspect, a network device for non-terrestrial network communication may comprise at least one processor and at least one memory including computer program code. The at least one memory and the computer program code are configured to, with the at least one processor, cause the network device at least to: obtain data relating to cell availability of at least one cell of a discontinuous non-terrestrial network having a discontinuous coverage and serving a user device; and cause transmission of the data relating to cell availability of at least one cell to the user device.

In an example embodiment, the at least one memory and the computer program code are configured to, with the at least one processor, cause the network device at least to cause transmission of the data relating to cell availability of at least one cell to the user device as a broadcast transmission.

In an example embodiment, the at least one memory and the computer program code are configured to, with the at least one processor, cause the network device at least to cause transmission of the data relating to cell availability of at least one cell to the user device as dedicated signaling.

In an example embodiment, the data relating to cell availability comprises one or more of the following: a cell availability time of at least cell provided by at least one satellite of the non-terrestrial network; a cell availability time of at least cell provided by at least one satellite of the non-terrestrial network at different elevation angles; a satellite periodicity relating to at least one satellite of the non-terrestrial network; a coverage radius of at least cell provided by at least one satellite of the non-terrestrial network; ephemeris data associated with at least one satellite of the non-terrestrial network; and a probability distribution between the satellites of the non-terrestrial network, the probability distribution providing probabilities of being in a radio coverage of a satellite during predetermined time windows.

In an example embodiment, one or more of the cell availability time, the satellite periodicity, the coverage radius, the ephemeris data or the probability distribution is location specific and/or time dependent.

According to a third aspect, a method for non-terrestrial network communication may comprise determining, by a user device, that a connection to a non-terrestrial network having a discontinuous coverage is unavailable, the non-terrestrial network providing at least one cell serving the user device; obtaining, by the user device, data relating to cell availability of the at least one cell; determining, by the user device, a backoff time associated with a subsequent non-terrestrial network search based at least partly on the data relating to cell availability; and initiating, by the user device, a cell search of the non-terrestrial network again after expiration of the backoff time.

According to a fourth aspect, a method for non-terrestrial network communication may comprise determining, by a network device, data relating to cell availability of at least one cell of a non-terrestrial network having a discontinuous coverage and serving a user device; and transmitting, by the network device, the data relating to cell availability of at least one cell to the user device.

According to a fifth aspect, there is provided a computer program comprising instructions for causing an apparatus to perform at least the following: determining that a connection to a non-terrestrial network having a discontinuous coverage is unavailable, the non-terrestrial network providing at least one cell serving the user device; obtaining data relating to cell availability of the at least one cell; determining a backoff time associated with a subsequent non-terrestrial network search based at least partly on the data relating to cell availability; and initiating a cell search of the non-terrestrial network again after expiration of the backoff time.

According to a sixth aspect, there is provided a computer program comprising instructions for causing an apparatus to perform at least the following: determining data relating to cell availability of at least one cell of a non-terrestrial network having a discontinuous coverage and serving a user device; and transmitting the data relating to cell availability of at least one cell to the user device.

According to a seventh aspect, a user device for non-terrestrial network communication may comprise means for: determining that a connection to a non-terrestrial network having a discontinuous coverage is unavailable, the non-terrestrial network providing at least one cell serving the user device; obtaining data relating to cell availability of the at least one cell; determining a backoff time associated with a subsequent non-terrestrial network search based at least partly on the data relating to cell availability; and initiating a cell search of the non-terrestrial network again after expiration of the backoff time.

According to an eighth aspect, a network device for non-terrestrial network communication may comprise means for: determining data relating to cell availability of at least one cell of a non-terrestrial network having a discontinuous coverage and serving a user device; and transmitting of the data relating to cell availability of at least one cell to the user device.

Many of the attendant features will be more readily appreciated as they become better understood by reference to the following detailed description considered in connection with the accompanying drawings.

### DESCRIPTION OF THE DRAWINGS

The accompanying drawings, which are included to provide a further understanding of the example embodiments and constitute a part of this specification, illustrate example embodiments and together with the description help to understand the example embodiments.

### In the Drawings:

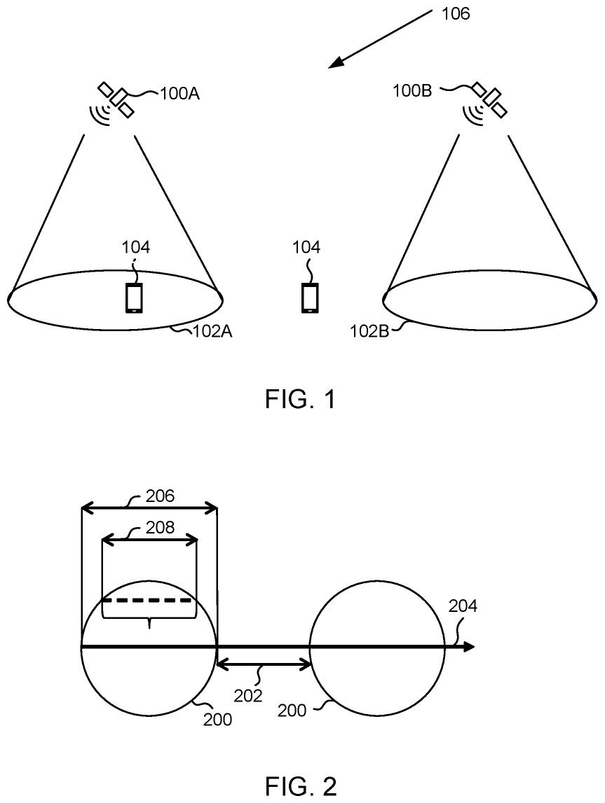

FIG. 1 illustrates discontinuous coverage in a non-terrestrial network.

FIG. 2 illustrates a relation between a coverage time and time with no coverage in a non-terrestrial network.

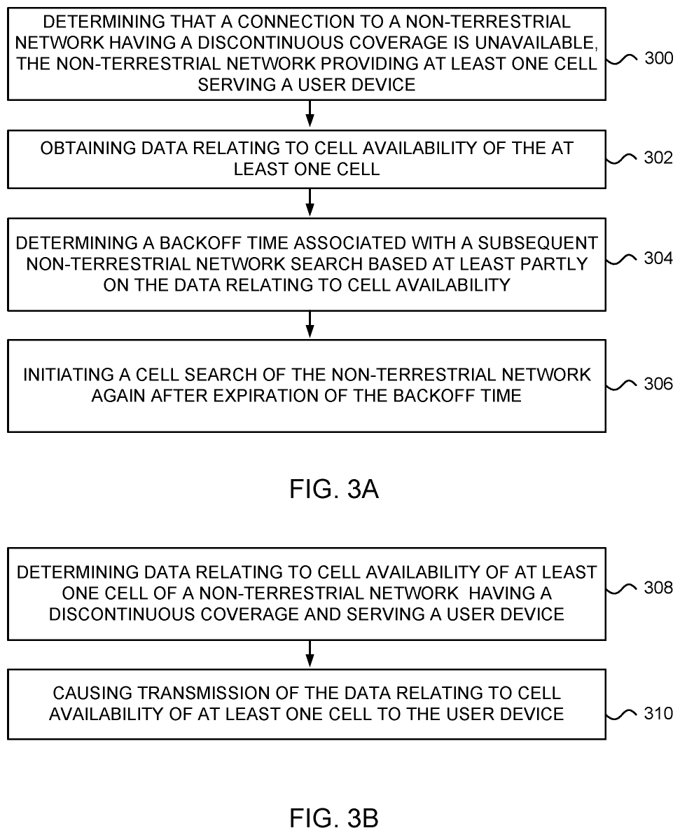

FIG. 3A illustrates an example of a method for non-terrestrial network communication according to an example embodiment.

FIG. 3B illustrates an example of a method for non-terrestrial network communication according to an example embodiment.

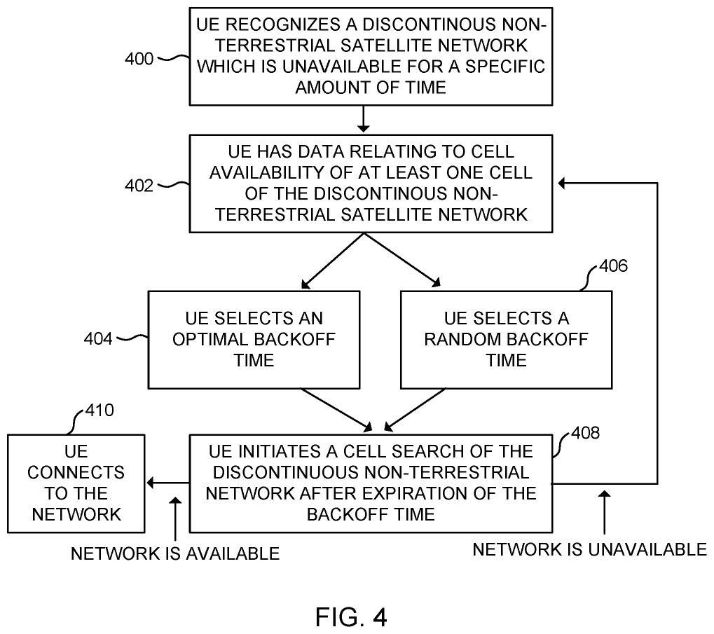

FIG. 4 illustrates an example of a method for non-terrestrial network communication according to an example embodiment.

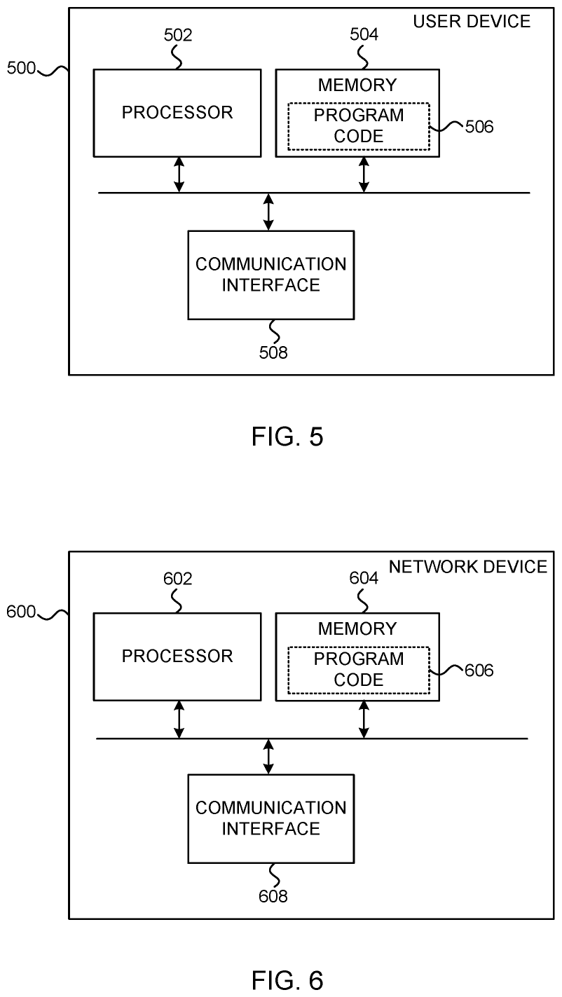

FIG. 5 illustrates an example of an apparatus configured to practice one or more example embodiments.

FIG. 6 illustrates an example of an apparatus configured to practice one or more example embodiments.

Like references are used to designate like parts in the accompanying drawings.

### DETAILED DESCRIPTION

Reference will now be made in detail to example embodiments, examples of which are illustrated in the accompanying drawings. The detailed description provided below in connection with the appended drawings is intended as a description of the present examples and is not intended to represent the only forms, in which the present example may be constructed or utilized. The description sets forth the functions of the example and the sequence of steps for constructing and operating the example. However, the same or equivalent functions and sequences may be accomplished by different examples.

FIG. 1 illustrates discontinuous coverage in a non-terrestrial network (NTN). The discontinuous coverage may refer to a situation in which at some specific time intervals, a user device 104, for example user equipment (UE), is not covered by any satellite 100 (for example, low-Earth orbit (LEO) or geostationary Earth orbit (GEO). When the user device 104 is not covered by any satellite 100, radio communication is not possible. This means that during these time intervals, cells 102A, 102B provided by base stations (i.e. gNBs) are only sporadically available to the UE 104. In an example embodiment, the discontinuous coverage can be either per design or just in the initial deployment of the constellation, where the number of satellites is insufficient to provide a continuous coverage. Further, although FIG. 1 illustrates that each satellite provides only one cell, in another example embodiment, a satellite or satellites may provide one or more cells. Further, when a satellite or satellites each provides multiple cells, the term “cell availability” may be replaced with “satellite availability”.

FIG. 2 illustrates a relation between a coverage time and time with no coverage in a non-terrestrial network.

Depending on a user device's position with respect to a cell center, cell availability of a cell 200 for the user device varies. A reference 206 refers to a maximum cell availability. A reference 208 refers to a minimum cell availability. A reference 202 refers to a situation in which there is no cell coverage for the user device. The “no cell coverage” time may depend on orbital parameters and the distance between two subsequent satellites. A reference 204 refers to a movement direction of the cell 200.

FIG. 3A illustrates an example of a method for non-terrestrial network (NTN) communication. The method may be performed by a user device, for example, a user equipment or an IoT device.

At 300 the user device may determine that a connection to an NTN having a discontinuous coverage is unavailable, the NTN providing at least one cell serving the user device.

At 302 the user device may to obtain data relating to cell availability of the at least one cell. The data may be obtained, for example, from a memory from the user device. In another example embodiment, the user device may obtain the data, for example, via the NTN.

At 304 the user device may determine a backoff time associated with a subsequent NTN search based at least partly on the data relating to cell availability.

At 306 the user device may initiate a cell search of the NTN again after expiration of the backoff time.

FIG. 3B illustrates an example of a method for non-terrestrial network (NTN) communication. The method may be performed by a network device, for example, a base station.

At 300 the network device may obtain data relating to cell availability of at least one cell of a NTN having a discontinuous coverage and serving a user device. The network node may first determine whether the user device is connected to the NTN. In an example embodiment, the network device may itself determine the data relating to cell availability of at least one cell of a NTN. In another example embodiment, the network device may obtain the data relating to cell availability of at least one cell of the NTN from at least one external entity, for example, a core network entity, a satellite control center, an NTN operations and management entity etc.

At 302 the network device may transmit the data relating to cell availability of at least one cell to the user device. The data may be provided to the user device while it is coverage of the NTN network.

FIG. 4 illustrates an example of a method for non-terrestrial network (NTN) communication according to an example embodiment.

A user device, for example, a user equipment (UE) may recognize 400 that the network it is trying to connect to is an NTN network having a discontinuous coverage and the network has been unavailable for a specific amount of time. At 402, the user device may check if it has data relating to cell availability about the network.

If the user device has the data relating to cell availability available, at 404 it may select an optimal backoff time based on the data. Otherwise, at 406 the user device may select a random backoff time. The backoff time relates to a time that the user device is configured to wait until it again tries to detect the NTN.

At 408 the user device tries to connect to the network after the backoff time. At 410, a connection to the network was successful. If the network is still unavailable, the processing goes back to the step 402, and the backoff time will be selected again.

In an example embodiment of any of the above examples and embodiments, the data relating to cell availability may comprise one or more of the following: a cell availability time of at least cell provided by at least one satellite of the NTN; a cell availability time of at least cell provided by at least one satellite of the NTN at different elevation angles (for example, 30 degrees, 90 degrees etc.); a satellite periodicity relating to at least one satellite of the NTN; a coverage radius of at least cell provided by at least one satellite of the NTN; ephemeris data associated with at least one satellite of the NTN; and a probability distribution between the satellites of the NTN, the probability distribution providing probabilities of being in a radio coverage of a satellite during predetermined time windows. The data relating to cell availability may have been received from the NTN. In another example embodiment, the data relating to cell availability may be obtained from a subscriber identity module (SIM) associated with the user device. In other words, the data relating to cell availability may be prestored in the SIM for a situation in which the user device performs a cold start. This may mean, for example, that the user device has not had any earlier connections to the NTN or it has moved a significant distance since the last time of the NTN connection. In an example embodiment, the cell availability time may be a network estimate of when the angle between the user device and a satellite is above a certain limit or the reference signal received power is above a certain limit (for example, in line of sight conditions).

In an example embodiment of any of the above or more of the cell examples and embodiments, one availability time, the satellite periodicity, the coverage radius, the ephemeris data or the probability distribution is location specific and/or time dependent.

In an example embodiment of any of the above examples and embodiments, the user device may obtain the data relating to cell availability of the at least one cell from the non-terrestrial network as a broadcast transmission or as dedicated signaling. In an example embodiment, the dedicated signaling may also be location specific. When sending the data as a broadcast transmission, the data may be received also by radio resource control (RRC) idle user devices. Thus, the same data may apply for a group of user devices, or the data may be different for different locations.

In an example embodiment, the user device may obtain the data relating to cell availability of the at least one cell based on information learned by the user device based at least partly on at least one previous availability of radio coverage of the non-terrestrial network. For example, the user device may store information about last coverage times, periodicity of the coverage etc. For example, a coverage time may provide information on how long the satellite was above a certain elevation angle relative to the location of the user device, or information on how long the radio coverage was available (for example, a reference signal received power (RSRP) above a certain threshold).

In an example embodiment of any of the above examples and embodiments, the data relating to the cell availability of the at least one cell may be associated with a validity time, and the user device may initiate the cell search of the non-terrestrial network based on the data relating to the cell availability of the at least one cell, when the data has a non-expired validity time. Thus, even if the user device has the data relating to the cell availability of the at least one cell, it may not necessarily be valid any more. Further, the user device may modify a cell search interval of the non-terrestrial network when the validity time has expired. The cell search interval may be modified, for example, based at least partly on time criticality of data to be sent by the user device. The user device may start, for example, a more aggressive search for a suitable cell with a shorter interval between cell searches. Further, if the user device does not find a cell and time passes on, the user device may become more aggressive with the search. In other words, the search frequency may be time dependent.

In an example embodiment of any of the above examples and embodiments, the user device may determine an accuracy of the data relating to cell availability, and apply a safety margin to the backoff time based on the accuracy. This may mean, for example, that in case the user device is insecure about an estimated coverage time, especially in a case of a short coverage duration, the user device can wake up a bit earlier to check for coverage in order not to miss any transmission opportunities. Further, in an example embodiment, the user device may determine the accuracy of the data relating to cell availability, for example, by comparing radio coverage measurements (of past cells) with the data relating to cell availability. Then, depending on how well the numbers match, the user device may add a safety margin to the backoff time.

In an example embodiment of any of the above examples and embodiments, the user device may determine the backoff time based on the probability distribution, a desired probability of being in a radio coverage of a satellite and a power consumption resulting from the desired probability. The probability distribution may be provided to the user device by the NTN network or it can be prestored in the user device. In an example embodiment, the probability distribution may be location specific and/or time dependent.

The probability distribution can be illustrated with the following example. The distribution may be as follows (no real pattern but random distribution over time):
20%: 1-10 minutes
50%: 10-20 minutes
20%: 20-30 minutes
5%: 30-40 minutes
3%: 40-50 minutes
2%: 50-60 minutes

This means, using the first row as an example, that after seeing one satellite, there is a 20% probability that the next satellite arrives within 1-10 minutes. Let's also assume that a satellite is just visible around a minute. The user device needs to send a packet about every 4th hour, and the sending is not delay critical.

The user device can now choose between different configurations:
Stay awake until it finds a satellite once it has data, which will lead to an average awake time of about 22 minutes
Stay awake for 20 minutes and then wait for 60 min and try again, which will lead to the following:
   70% of the time the user device finds a satellite in less than 20 minutes (average: 12.1 minutes)
   21% of the time the user device finds a satellite in the second try (average: 20+12.1=32.1 minutes)
   6% of the time the user device finds a satellite in the third try (average: 40+12.1=52.1 minutes)
   1.9% of the time the user device finds a satellite in the fourth try (average: 60+12.1=72.1 minutes)
   The next try will fall together with the next packet to be send (used in 1.1% of the time).
This leads to an average search time of 19.8 minutes (approximately 10% gain).

The gain may depend on the distribution, and especially in the case of long tails, there is a clear gain.

In an example embodiment of any of the above examples and embodiments, the user device may be a mobile user device. In other words, in addition to moving cells, also the user device may move within the cells. In an example embodiment, the user device may determine a difference between an earlier location of the user device and a current location of the user device, and determine the backoff time based at least partly on the data relating to cell availability and the difference between the earlier location of the user device and the current location of the user device. Alternatively, a validity range for the data relating to cell availability of the at least one cell provided to the user device can be added. The data relating to cell availability may then be considered invalid when the user device moves out of the validity range.

In an example embodiment of any of the above examples and embodiments, the user device may determine a temporal distance to a nearest cell availability time, and determine the backoff time at least partly based on the temporal distance. The may enable a shorter back-off because of the accuracy of the network provided data relating to cell availability of the at least one cell.

One of more of the above discussed examples and embodiments may enable a solution for balancing between delay and power saving. One of more of the above discussed examples and embodiments may also enable a solution that takes into account movement of the user device.

FIG. 5 illustrates an example of an apparatus 500 configured to practice one or more example embodiments. The apparatus 500 may comprise at least one processor 502. The at least one processor 502 may comprise, for example, one or more of various processing devices or processor circuitry, such as, for example, a co-processor, a microprocessor, a controller, a digital signal processor (DSP), a processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, or the like.

The apparatus 500 may further comprise at least one memory 504. The at least one memory 504 may be configured to store, for example, computer program code or the like, for example, operating system software and application software. The at least one memory 504 may comprise one or more volatile memory devices, one or more non-volatile memory and/or a combination thereof. For example, the at least one memory 504 may be embodied as magnetic storage devices (such as hard disk drives, floppy disks, magnetic tapes, etc.), optical magnetic storage devices, or semiconductor memories (such as mask ROM, PROM (programmable ROM), EPROM (erasable PROM), flash ROM, RAM (random access memory), etc.).

The apparatus may 500 further comprise a communication interface 508 configured to enable apparatus 500 to transmit and/or receive information to/from other devices. In one example, the apparatus 500 may use the communication interface 508 to transmit or receive signaling information and data in accordance with at least one data communication or cellular communication protocol. The communication interface 508 may be configured to provide at least one wireless radio connection, such as, for example, a 3GPP mobile broadband connection (e.g. 3G, 4G, 5G, 6G etc.). In another example embodiment, the communication interface 508 may be configured to provide one or more other type of connections, for example a wireless local area network (WLAN) connection such as for example standardized by IEEE 802.11 series or Wi-Fi alliance; a short range wireless network connection such as for example a Bluetooth, NFC (near-field communication), or RFID connection; a wired connection, for example, a local area network (LAN) connection, a universal serial bus (USB) connection or an optical network connection, or Internet connection. The the like; or a wired communication interface 508 may comprise, or be configured to be coupled to, at least one antenna to transmit and/or receive radio frequency signals. One or more of the various types of connections may be also implemented as separate communication interfaces, which may be coupled or configured to be coupled to one or more of a plurality of antennas.

When the apparatus 500 is configured to implement some functionality, some component and/or components of the apparatus 500, for example, the at least one processor 502 and/or the at least one memory 504, may be configured to implement this functionality. Furthermore, when the at least one processor 502 is configured to implement some functionality, this functionality may be implemented using the program code 506 comprised, for example, in the at least one memory 504.

The functionality described herein may be performed, at least in part, by one or more computer program product components such as software components. According to an embodiment, the apparatus may comprise a processor or processor circuitry, for example, a microcontroller, configured by the program code when executed to execute the embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), application-specific Integrated Circuits (ASICs), application-specific Standard Products (ASSPs), System-on-a-chip systems (SOCs), Complex Programmable Logic Devices (CPLDs), and Graphics Processing Units (GPUS).

The apparatus 500 may comprise means for performing at least one method described herein. In an example embodiment, the means may comprise the at least one processor 502, the at least one memory 504 including program code 506 configured to, when executed by the at least one processor, cause the apparatus 500 to perform the method.

The apparatus 500 may comprise, for example, a computing device, for example, a mobile device, a mobile phone, a user device, a user equipment, a user node, a tablet computer, a laptop, an internet of things (IoT) device, a tag, or the like. Examples of IoT devices include, but are not limited to, consumer electronics, wearables, sensors, and smart home appliances. Although the apparatus 500 is illustrated as a single device it is appreciated that, wherever applicable, functions of the apparatus 500 may be distributed to a plurality of devices, for example, to implement example embodiments as a cloud computing service.

An apparatus, for example, a device such as a mobile device, a mobile phone, a user device, a user equipment, a user node, a tablet computer, a laptop, an internet of things (Iot) device, or a tag, may be configured to perform or cause performance of any aspect of the method(s) described herein. Further, a computer program may comprise instructions for causing, when executed, an apparatus to perform any aspect of the method(s) described herein. The computer program may be stored on a computer-readable medium. Further, an apparatus may comprise means for performing any aspect of the method(s) described herein. According to an example embodiment, the means comprises at least one processor, and at least one memory including program code, the at least one processor, and program code configured to, when executed by the at least one processor, cause performance of any aspect of the method(s).

FIG. 6 illustrates an example of an apparatus 600 configured to practice one or more example embodiments. The apparatus 600 may comprise at least one processor 602. The at least one processor 602 may comprise, for example, one or more of various processing devices or processor circuitry, such as, for example, a co-processor, a microprocessor, a controller, a digital signal processor (DSP), a processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, or the like.

The apparatus 600 may further comprise at least one memory 604. The at least one memory 604 may be configured to store, for example, computer program code or the like, for example, operating system software and application software. The at least one memory 604 may comprise one or more volatile memory devices, one or more non-volatile memory devices, and/or a combination thereof. For example, the at least one memory 604 may be embodied as magnetic storage devices (such as hard disk drives, floppy disks, magnetic tapes, etc.), optical magnetic storage devices, or semiconductor memories (such as mask ROM, PROM (programmable ROM), EPROM (erasable PROM), flash ROM, RAM (random access memory), etc.).

The apparatus 600 may further comprise a communication interface 608 configured to enable apparatus 600 to transmit and/or receive information to/from other devices. In one example, the apparatus 600 may use the communication interface 608 to transmit or receive signaling information and data in accordance with at least one data communication or cellular communication protocol. The communication interface 608 may be configured to provide at least one wireless radio connection, such as, for example, a 3GPP mobile broadband connection (e.g. 3G, 4G, 5G, 6G etc.). In another example embodiment, the communication interface 608 may be configured to provide one or more other type of connections, for example a wireless local area network (WLAN) connection such as for example standardized by IEEE 802.11 series or Wi-Fi alliance; a short range wireless network connection such as for example a Bluetooth, NFC (near-field communication), or RFID connection; a wired connection, for example, a local area network (LAN) connection, a universal serial bus (USB) connection or an optical network connection, or the like; or a wired Internet connection. The communication interface 608 may comprise, or be configured to be coupled to, at least one antenna to transmit and/or receive radio frequency signals. One or more of the various types of connections may be also implemented as separate communication interfaces, which may be coupled or configured to be coupled to one or more of a plurality of antennas.

When the apparatus 600 is configured to implement some functionality, some component and/or components of the apparatus 600, for example, the at least one processor 602 and/or the at least one memory 604, may be configured to implement this functionality. Furthermore, when the at least one processor 602 is configured to implement some functionality, this functionality may be implemented using the program code 606 comprised, for example, in the at least one memory 604.

The functionality described herein may be performed, at least in part, by one or more computer program product components such as software components. According to an embodiment, the apparatus may comprise a processor or processor circuitry, for example, a microcontroller, configured by the program code when executed to execute the embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), application-specific Integrated Circuits (ASICs), application-specific Standard Products (ASSPs), System-on-a-chip systems (SOCs), Complex Programmable Logic Devices (CPLDs), and Graphics Processing Units (GPUs).

The apparatus 600 may comprise means for performing at least one method described herein. In an example embodiment, the means may comprise the at least one processor 602, the at least one memory 604 including program code 606 configured to, when executed by the at least one processor, cause the apparatus 600 to perform the method.

The apparatus 600 may comprise, for example, a computing device, for example, a base station, a server, a network node, a cloud node or the like. Although the apparatus 600 is illustrated as a single device it is appreciated that, wherever applicable, functions of the apparatus 600 may be distributed to a plurality of devices, for example, to implement example embodiments as a cloud computing service.

An apparatus, for example, a device such as a base station, a server, a network node, or a cloud node, may be configured to perform or cause performance of any aspect of the method(s) described herein. Further, a computer program may comprise instructions for causing, when executed, an apparatus to perform any aspect of the method(s) described herein. The computer program may be stored on a computer-readable medium. Further, an apparatus may comprise means for performing any aspect of the method(s) described herein. According to an example embodiment, the means comprises at least one processor, and at least one memory including program code, the at least one processor, and program code configured to, when executed by the at least one processor, cause performance of any aspect of the method(s).

Any range or device value given herein may be extended or altered without losing the effect sought. Also, any embodiment may be combined with another embodiment unless explicitly disallowed.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item may refer to one or more of those items.

The steps or operations of the methods described herein may be carried out in any suitable order, or simultaneously where appropriate. Additionally, individual blocks may be deleted from any of the methods without departing from the scope of the subject matter described herein. Aspects of any of the embodiments described above may be combined with aspects of any of the other embodiments described to form further embodiments without losing the effect sought.

The term ‘comprising’ is used herein to mean including the method, blocks, or elements identified, but that such blocks or elements do not comprise an exclusive list and a method or apparatus may contain additional blocks or elements.

As used in this application, the term ‘circuitry’ may refer to one or more or all of the following: (a) hardware-only circuit implementations (such as implementations in only analog and/or digital circuitry) and (b) combinations of hardware circuits and software, such as (as applicable): (i) a combination of analog and/or digital hardware circuit(s) with software/firmware and (ii) any portions of hardware processor(s) with software (including digital signal processor(s)), software, and memory (ies) that work together to cause an apparatus, such as a mobile phone or server, to perform various functions) and (c) hardware circuit(s) and processor(s), a or such as microprocessor(s) or a portion of a microprocessor(s), that requires software (e.g., firmware) for operation, but the software may not be present when it is not needed for operation. This definition of circuitry applies to all uses of this term in this application, including in any claims.

As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from scope of this specification.

The invention claimed is:

1-25. (canceled)

26. A user device for non-terrestrial network communication, the user device comprising:
at least one processor; and
at least one memory including computer program code, the at least one memory and the computer program code configured to, with the at least one processor, cause the user device at least to:
determine that a connection to a non-terrestrial network having a discontinuous coverage is unavailable, the non-terrestrial network providing at least one cell serving the user device;
obtain data relating to cell availability of the at least one cell;
determine a backoff time associated with a subsequent non-terrestrial network search based at least partly on the data relating to cell availability; and
initiate a cell search of the non-terrestrial network again after expiration of the backoff time.

27. The user device according to claim 26, wherein the at least one memory including computer program code, the at least one memory and the computer program code are configured to, with the at least one processor, cause the user device at least to:
obtain the data relating to cell availability of the at least one cell from a subscriber identity module associated with the user device.

28. The user device according to claim 26, wherein the at least one memory including computer program code, the at least one memory and the computer program code (506) are configured to, with the at least one processor, cause the user device at least to:
obtain the data relating to cell availability of the at least one cell from the non-terrestrial network as a broadcast transmission.

29. The user device according to claim 26, wherein the at least one memory including computer program code, the at least one memory and the computer program code are configured to, with the at least one processor, cause the user device at least to:
obtain the data relating to cell availability of the at least one cell from the non-terrestrial network as dedicated signaling.

30. The user device according to claim 26, wherein the at least one memory including computer program code, the at least one memory and the computer program code are configured to, with the at least one processor, cause the user device at least to:
obtain the data relating to cell availability of the at least one cell based on information learned by the user device based at least partly on at least one previous availability of radio coverage of the non-terrestrial network.

31. The user device according to claim 26, wherein the data relating to the cell availability of the at least one cell is associated with a validity time, and the at least one memory including computer program code, the at least one memory and the computer program code are configured to, with the at least one processor, cause the user device at least to:
initiate the cell search of the non-terrestrial network based on the data relating to the cell availability of the at least one cell, when the data has a non-expired validity time.

32. The user device according to claim 31, wherein the at least one memory including computer program code, the at least one memory and the computer program code are configured to, with the at least one processor, cause the user device at least to:
modify a cell search interval of the non-terrestrial network when the validity time has expired.

33. The user device according to claim 32, wherein the cell search interval is modified based at least partly on time criticality of data to be sent by the user device.

34. The user device according to claim 26, wherein the at least one memory including computer program code, the at least one memory and the computer program code are configured to, with the at least one processor, cause the user device at least to:
determine an accuracy of the data relating to cell availability; and
apply a safety margin to the backoff time based on the accuracy.

35. The user device according to claim 26, wherein the data relating to cell availability comprises one or more of the following:
a cell availability time of at least cell provided by at least one satellite of the non-terrestrial network;
a cell availability time of at least cell provided by at least one satellite of the non-terrestrial network at different elevation angles;
a satellite periodicity relating to at least one satellite of the non-terrestrial network;
a coverage radius of at least cell provided by at least one satellite of the non-terrestrial network;
ephemeris data associated with at least one satellite of the non-terrestrial network; and
a probability distribution between the satellites of the non-terrestrial network, the probability distribution providing probabilities of being in a radio coverage of a satellite during predetermined time windows.

36. The user device according to claim 35, wherein one or more of the cell availability time, the satellite periodicity, the coverage radius, the ephemeris data or the probability distribution is location specific and/or time dependent.

37. The user device according to claim 36, wherein the at least one memory including computer program code, the at least one memory and the computer program code are configured to, with the at least one processor, cause the user device at least to:
determine the backoff time based on the probability distribution, a desired probability of being in a radio coverage of a satellite and a power consumption resulting from the desired probability.

38. The user device according to claim 36, wherein the probability distribution between the satellites of the non-terrestrial network is location specific and/or time dependent.

39. The user device according to claim 36, wherein the at least one memory including computer program code, the at least one memory and the computer program code are configured to, with the at least one processor, cause the user device at least to:
determine a temporal distance to a nearest cell availability time; and
determine the backoff time at least partly based on the temporal distance.

40. The user device according to any of claim 26, wherein the user device is a mobile user device.

41. The user device according to claim 40, wherein the at least one memory including computer program code, the at least one memory and the computer program code are configured to, with the at least one processor, cause the user device at least to:
determine a difference between an earlier location of the user device and a current location of the user device; and
determine the backoff time based at least partly on the data relating to cell availability and the difference between the earlier location of the user device and the current location of the user device.

42. A network device for non-terrestrial network communication, the network device comprising:
at least one processor; and
at least one memory including computer program code, the at least one memory and the computer program code configured to, with the at least one processor, cause the network device at least to:
obtain data relating to cell availability of at least one cell of a non-terrestrial network having a discontinuous coverage and serving a user device; and
cause transmission of the data relating to cell availability of at least one cell to the user device.

43. The network device according to claim 42, wherein the at least one memory including computer program code, the at least one memory and the computer program code are configured to, with the at least one processor, cause the network device at least to:
cause transmission of the data relating to cell availability of at least one cell to the user device as a broadcast transmission.

44. The network device according to claim 42, wherein the at least one memory including computer program code, the at least one memory and the computer program code are configured to, with the at least one processor, cause the network device at least to:
cause transmission of the data relating to cell availability of at least one cell to the user device as dedicated signaling.

45. The network device according to claim 42, wherein the data relating to cell availability comprises one or more of the following:
a cell availability time of at least cell provided by at least one satellite of the non-terrestrial network;
a cell availability time of at least cell provided by at least one satellite of the non-terrestrial network at different elevation angles;
a satellite periodicity relating to at least one satellite of the non-terrestrial network;
a coverage radius of at least cell provided by at least one satellite of the non-terrestrial network;
ephemeris data associated with at least one satellite of the non-terrestrial network; and
a probability distribution between the satellites of the non-terrestrial network, the probability distribution providing probabilities of being in a radio coverage of a satellite during predetermined time windows.
